(19) United States
(12) Patent Application Publication
(10) Pub. No.: US 2024/0380227 A1
(43) Pub. Date: Nov. 14, 2024

(54) PORTABLE POWER SYSTEM, ACCESSORIES, AND METHODS

(71) Applicants: George A. Van Straten, Chassell, MI (US); Eric Prue, Marquette, MI (US)

(72) Inventors: George A. Van Straten, Chassell, MI (US); Eric Prue, Marquette, MI (US)

(21) Appl. No.: 18/660,558

(22) Filed: May 10, 2024

Related U.S. Application Data
(60) Provisional application No. 63/465,272, filed on May 10, 2023.

(51) Int. Cl. H02J 7/00; H01M 10/46

(52) U.S. Cl. CPC H02J 7/0045; H01M 10/465; H02J 7/0049; H02J 7/0063

(57) ABSTRACT

A portable power system utilizing a motor vehicle as its base. The system comprises a power stack that includes an electric nest that is fixed to the vehicle. The power stack comprises an interlocked stack of components having a power module at a superior end that is releasably coupled to the electric nest. The power stack includes one or more batteries intermediate to the electric nest and power module. Electric accessories can be connected to the power system either to supply power to the portable power system to charge the batteries, or to provide power to one or more connected electronic devices for charging or operation. The device can then be used as a completely portable power station by detaching the power module and one or more batteries from the electric nest. By attachment of a portable solar panel, the portable power system can recharge.

### CROSS REFERENCE TO RELATED APPLICATIONS

This application claims priority to Provisional Patent Application No. 63/465,272 filed May 10, 2023, the entire disclosure of which is hereby incorporated by reference and relied upon.

### BACKGROUND OF THE INVENTION

Field of the Invention. The invention relates generally to portable power systems, and more particularly to portable power systems associated with motor vehicles, accessories associated with these power systems, and methods of use.

Prior art Portable power systems have traditionally been in the form of gas-powered systems. These systems are loud, heavy, create air pollution, and require the purchase of fossil fuels to operate. In addition, these systems are not always reliable, and are often difficult to start especially if the fuel is old or the engines have been sitting for extended periods. Battery powered portable power systems are also available. They are typically carried to a point of use such as a campground to power or charge electric accessories.

What is needed is a portable power system that can be quickly attached and released from a motor vehicle. What is needed is a portable power system that when attached to the motor vehicle can provide a charging current to various electric accessories attached to the vehicle without repeated connecting and disconnecting of cables. What is needed is a portable power system where a variable number of batteries can remain with the vehicle to charge accessories and the remaining batteries remaining with a power module that can be moved to a location where needed. What is needed are portable power systems that can receive power from solar panels in addition to receiving power from a motor vehicle's power plant or commercial power source.

### SUMMARY OF THE INVENTION

Disclosed herein is a portable power system that utilizes a motor vehicle as its base and meets the needs described above.

In one form, a portable power system comprises a power stack that includes an electric nest that is fixed to the vehicle.

In one form, the power stack comprises a stack of components that can be interlocked with each other.

In one form, a power stack includes one or more intermediate batteries and a power module at a superior end releasably coupled to the electric nest at an inferior end.

In one form, a variety of electric accessories can be connected to the power system either to supply power to the portable power system thereby charging the battery stack, or to provide power to one or more connected electronic devices for charging or operation.

In one form, by detaching the power module and one or more batteries from the electric nest, the system can then be used as a completely portable power station that can be taken to remote locations such as in the middle of the woods.

In one form, by attachment of a portable solar panel, the portable power system will recharge itself.

In one form, a power stack is secured to a convenient location on a motor vehicle such as on the vehicle floor, within a truck bed next to the vehicle wall of the bed, or in the trunk of a vehicle.

In one form, the power stack comprises a power module that releasably mates with one or more batteries.

In one form, an electric nest comprises a generally square or rectangular nest body having a downward facing mate face and an upward facing base face.

In one form, a nest electrical pod extends upward from a floor face and terminates at a pod upper face.

In one form, integrated into the electric nest, are a plurality of electrical ports for the intake of electrical signals or power, and/or the output of electrical signals or power.

In one form, electrical conductors extending from the electrical ports can use any electrical connectors known in the art for this purpose for fixed or releasable connection.

In one form, each electrical port and conductor can be configured to have any number of sub conductors contained within. For example, a first conductor can include a first wire, second wire, third wire, fourth wire etc. contained inside. The electrical ports can be configured to receive electrical energy such as for example from a solar panel, electrical outlet, or battery. Conversely, the electrical ports can be configured to supply electrical energy of various voltage and amperage such as for example, to run an appliance, or to charge an electric bike, a cell phone, or other motorized electric device. The electrical ports can also be used for other electrical transmissions such as data.

In one form, a power module comprises a module body that is substantially block like although other profiles can be used that are conducive to mating with a battery.

In one form, a power module in an operational configuration, comprises an interlocking architecture for interlocking with a battery.

In one form, the power module comprises an operational face on which various electrical ports and power display are located. For example, the electrical ports can include DC supply ports such as a USB-C, a 5V supply, a Qualcomm USB 5V quick charge, and a 12V supply such as a car plug. The electrical ports can include an AC supply port such as a 110V electrical outlet and can also include a power input port such as to receive energy from a solar panel.

In one form, the power module includes any combination of the following: a power display to display various information such as the input power that is received, the output power that is being delivered such as to a connected electric heater, a charge monitor to indicate the percentage of battery charge wherein 100% indicates full charge, a display control button to turn the display on and off, a fuse to protect circuits, an output time display indicating how long the battery power will last at the current output, an input time display indicating the amount of time until full charge, and an on/off control to power or shut down the power module.

In one form, in an operational configuration, a power stack includes one or more stacked batteries positioned between the power module and electric nest.

In one form, components of a power stack have a releasable interlock architecture providing releasable fixation between the components. Various types of interlocking mechanisms known in the art can be used for this same purpose.

In one form, batteries used in the power stack can assume a variety of profiles provided they have architecture conducive to releasably mating to some form of electric nest and power module.

In one form, a method for engaging and disengaging a power stack to an electric nest includes aligning the power stack above the electric nest. Tilting the power stack such that the exposed toe lip is angled downward. Engaging the toe lip in the toe receiver of the electric nest. Lowering the power stack such that the battery heel is seated in the heel receiver of the electric nest, and latching the restraint arm to the lower latch portion thereby securing the power stack. Removal of the power module and one or more batteries from remaining batteries and electric nest is a reversal of these steps.

In one form, various power input devices such as a solar panel can be attached to provide power to the system and charge the battery.

In one form, battery stack batteries are releasably coupled by the use of a mating plate that is releasably fixed to the bottom of the batteries. The mating plate interlocks with one end of a battery and the other end of the mating plate is fixed to the battery by use of an interlock fastener disposed in an interlock faster hole.

In one form, extending vertically into the superior face of the batteries is an interlock pin hole configured to house an interlock pin and interlock spring that biases the interlock pin upwards to interfere with the mating plate thereby preventing translation of an adjacent battery and thus preventing release of the battery from the mating plate.

In one form, an interlock release button is housed within mating plate and is aligned with the interlock pin in an operational configuration.

In one form, terminals in the batteries communicate with battery cells in the batteries whereas other terminals in the batteries carry other electrical signals up and down the stack of batteries for operation of the electrical nest, accessories connected to it, and to the power module.

In one form, a mating plate comprises an upper mate face that generally complements the profile of the bottom side of the batteries.

In one form, the upper mate face is sloped on each end to match the round nature of the bottom of the battery at its ends.

In one form, the lower mate face is generally flat to facilitate translatory engagement with the top of the adjacent battery.

In one form, an electrical nest comprises a foot receiver side wall that encircles the electrical nest and which defines an electrical port cavity that extends upwards towards a foot receiver floor and downward face.

In one form, extending laterally through the foot receiver wall are a plurality of electrical ports.

In one form, retractable electrical cords extend through the electrical ports to various accessories including solar panels.

In one form, a portable power system comprises an electric nest that is smart in that it recognizes and coordinates power between battery stacks and implements actions to control power between stacks.

In one form, the electric nest displays power information typically found only on the power module. Therefore, even with the power module and a battery removed from the power stack, the user can read the same information from the electric nest (i.e. charge status, how many batteries are being charged, etc.). In addition, the batteries connected to the electric nest can be used to charge electrical accessories even in the absence of a power module.

In one form, the electrical nest is ‘smart’ in that it has sensors to know what accessories are connected to it and is able to take appropriate actions depending on the electrical needs of the devices. In addition, the ‘smart’ electrical nest senses other electrical nests that are electrically joined to it.

In one form, a power module and one or more batteries from a power stack are removed. The remaining electrical nest and remaining batteries remain available to provide power to accessories electrically coupled to the electrical nest. In addition, solar panels electrically coupled to the electric nest can provide power to the nest for recharging the batteries.

### BRIEF DESCRIPTION OF THE SEVERAL VIEWS OF THE DRAWINGS

These and other features and advantages of the present invention will become more readily appreciated when considered in connection with the following detailed description and appended drawings, wherein each drawing is according to one or more embodiments shown and described herein, and wherein:

FIG. 1 depicts a perspective view of a motor vehicle with a power stack coupled to an electric nest that is fixed to the vehicle;

FIG. 2 depicts a close up perspective view of the power stack and electric nest of FIG. 1;

FIG. 3 depicts a perspective view of the power stack and electric nest of FIG. 1 and various electrical ports;

FIG. 4 depicts a perspective view of the power stack and electric nest of FIG. 1 and various conductors extending therefrom;

FIG. 5 depicts a perspective view of the power stack and electric nest of FIG. 1 noting various batteries;

FIG. 6 depicts a perspective view of the power stack and electric nest of FIG. 1 and highlighting latches used to secure the batteries;

FIG. 7 depicts a closeup perspective view of a latch utilized to releasably secure portions of the power stack together;

FIG. 8 depicts a bottom perspective view of the electric nest of FIG. 1;

FIG. 9 depicts a top perspective view of the electric nest of FIG. 1;

FIG. 10 depicts a bottom perspective view of a battery utilized in the power stack of FIG. 1;

FIG. 11 depicts a side view of a battery utilized in the power stack of FIG. 1;

FIG. 12 depicts a top perspective view of a battery utilized in the power stack of FIG. 1;

FIG. 13 depicts a bottom perspective view of a battery and its toe lip utilized to interlock members of the power stack of FIG. 1;

FIG. 14 depicts a side view of two batteries latched together of the power stack of FIG. 1;

FIG. 15 depicts a side view of a power stack in one step of engaging and disengaging the power stack to an electric nest;

FIG. 16 depicts a side view of a power stack in one step of engaging and disengaging the power stack to an electric nest;

FIG. 17 depicts a side view of a power stack in one step of engaging and disengaging the power stack to an electric nest;

FIG. 18 depicts a side view of a power stack in one step of engaging and disengaging the power stack to an electric nest;

FIG. 19 depicts a side view of a power stack in one step of engaging and disengaging the power stack to an electric nest;

FIG. 20 is a graphic depicting the electrical relationship between components of a power stack and electric nest;

FIG. 21 is a graphic depicting the electrical relationship between a power module and one or more stacked batteries;

FIG. 22 is a graphic depicting mating a battery from the system to an electric device;

FIG. 23 depicts a perspective view of a battery stack utilized in a power stack;

FIG. 24 depicts an opposed perspective view of a battery stack coupled with an electric nest;

FIG. 25 depicts a perspective view of a battery utilized in the battery stack of FIG. 24;

FIG. 26 depicts a hidden line view of the battery of FIG. 25 depicting various fasteners and pins;

FIG. 27 depicts a top exploded perspective view of the battery of FIG. 25;

FIG. 28 depicts a bottom perspective view of the battery of FIG. 25;

FIG. 29 depicts a top perspective view of the battery of FIG. 25 mated to a mating plate;

FIG. 30 depicts a closeup view of components to secure the mating plate and for interlocking stacked batteries;

FIG. 31 depicts a closeup view of a battery between two mating plates;

FIG. 32 depicts a top perspective view of a mating plate;

FIG. 33 depicts an opposed perspective view of the mating plate of FIG. 32;

FIG. 34 depicts a bottom perspective view of the mating plate of FIG. 32;

FIG. 35 depicts a top perspective view of an electric nest;

FIG. 36 depicts a bottom perspective view of the electric nest of FIG. 35;

FIG. 37 depicts a schematic of electrical components utilized in a portable power system.

### DETAILED DESCRIPTION OF SELECTED EMBODIMENTS OF THE INVENTION

Select embodiments of the invention will now be described with reference to the Figures. Like numerals indicate like or corresponding elements throughout the several views and wherein various embodiments are separated by letters (i.e. 100, 100B, 100C). The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

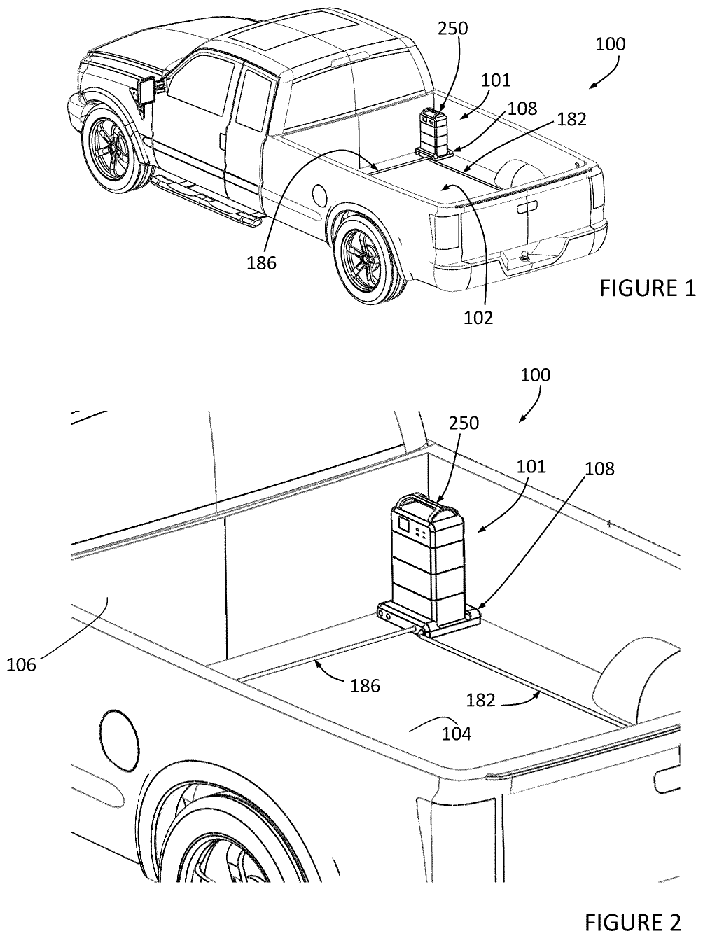

FIG. 1 depicts a motor vehicle 100 with a power stack 101. The power stack 101 is secured to a convenient location on a motor vehicle such as on the vehicle floor 104 within a truck bed 102 next to the vehicle wall 106 of the bed or in the trunk of a vehicle. The power stack 101 comprises a power module 250 that releasably mates with one or more batteries. For example, as illustrated in an operational configuration in FIG. 5, the power stack 101 comprises an electric nest 108 mounted to the vehicle that serves as a secure base for first battery 200, second battery 202, third battery 204, and terminating in power module 250.

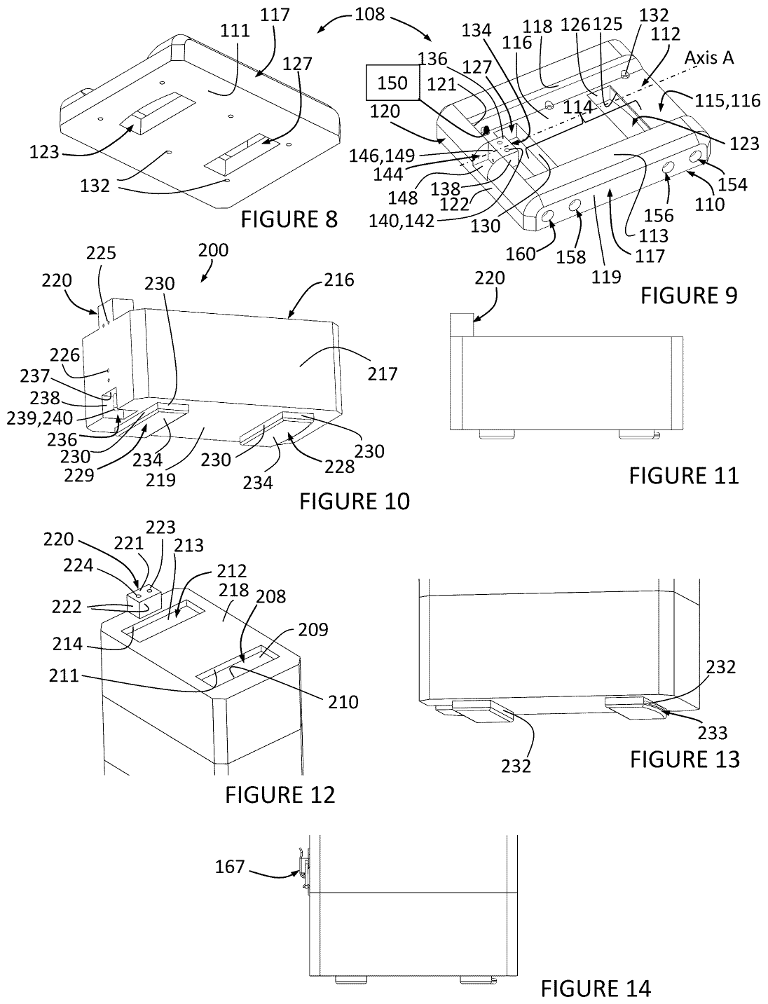

In this embodiment (FIG. 8-9), the electric nest 108 comprises a generally square or rectangular nest body 110 having a downward facing mate face 111 and an upward facing base face 113. A battery inset 112 descends downward partially into the nest body 110 from the base face 113 and stopping at foot receiver floor 115 with floor face 116 thereon. Extending into floor face 116 is a foot receiver 114 for receiving portions of a battery for removable fixation to the electric nest 108. The foot receiver 114 comprises a heel receiver 127 spaced from a toe receiver 123 with both extending through the floor face 116. In some embodiments, the toe receiver and foot receiver extend only partially into the nest body, however, in this embodiment, they extend all the way through the nest body 110 as depicted in FIG. 8.

Surrounding the battery inset 112 on 2 sides are opposing foot receiver side walls 117 which are joined by foot receiver center wall 120 forming a generally U-shaped upstanding wall. Inner faces 118 on the foot receiver side walls face central axis A, whereas, outer faces 119 on the foot receiver side walls face away from central axis A. The battery inset 112 is also defined by inner face 121 on foot receiver center wall 120 facing towards the battery inset with outer surface 122 facing away from the battery inset.

The heel receiver 127 is defined by a heel receiver face 130 extending between floor face 116 and mate face 111 (or an upward facing heel receiver floor 128 if present). In this embodiment, the heel receiver has a generally rectangular profile, but other profiles can be used. The toe receiver 123 is defined by a toe receiver face 126 extending between floor face 116 and mate face 111 (or an upward facing toe receiver floor 124 if present). At one end of the toe receiver 123 is a toe receiver roof 125 that partially extends over the toe receiver 123 to block a toe lip 233 of a battery mated to the electric nest 108 to assist securing the battery to the electric nest.

A plurality of fixation holes 132 extend between the floor face 116 and mate face 111 for housing fasteners 150 that secure the electric nest 108 to a portion of a motor vehicle 100. Alternatively, the fixation holes can extend between base face 113 and mate face 111.

In this embodiment, a nest electrical pod 134 extends upward from floor face 116 and terminates at pod upper face 136. The electrical pod 134 in this embodiment is in a generally square block form, but can assume a variety of forms that complement the respective feature on a mating battery. Here, the nest electrical pod 134 is defined by pod side faces 138 extending between pod upper face 136 and floor face 116. Extending into pod upper face 136 is first pod contact 140 and second pod contact 142 which again complement the respective electrical features on a mating battery (i.e. first battery 200). Aligned with electrical pod 134 and extending through foot receiver center wall 120 to electrical pod 134 is latch window 144 which is defined latch side faces 148 and latch face 146 adjacent to the electrical pod. Latch mount holes 149 extend into latch face 146 to house fasteners for securing a lower latch portion 176 to latch face 146.

Integrated into the electric nest 108, are a plurality of electrical ports for the intake of electrical signals or power and/or the output of electrical signals or power. In the embodiment of FIG. 9, the electrical ports extend through outer face 119 into foot receiver side wall 117. These electrical ports however, can be located on other faces of the electrical nest such as base face 113 or even through mate face 111 when porting conductors behind walls such as the floor of a truck bed. In this embodiment, first electrical port 154, second electrical port 156, third electrical port 158, and fourth electrical port 160 extend through outer face 119 (and any number of additional electrical ports such as for example a fifth electrical port 162 and sixth electrical port 164). Electrical conductors extending from these ports can use any electrical connectors known in the art for this purpose for fixed or releasable connection. Example of electrical conductors are illustrated in at least FIG. 1 whereby first conductor 182 is depicted having a first conductor first end 183 (FIG. 4) and a second conductor second end 184 (not shown), and whereby second conductor 186 is depicted having a second conductor first end 187 and a second conductor second end 188 (not shown). Similarly other electrical ports (not shown) can be utilized using respectively for example, a third conductor 190 (FIG. 5) having a third conductor first end 191 and a third conductor second end 192, and a fourth conductor 194 having a fourth conductor first end 195 and a fourth conductor second end 196 etc.

Each electrical port and conductor can be configured to have any number of sub conductors contained within. For example, the first conductor can include a first wire, second wire, third wire, fourth wire etc. contained inside. The electrical ports can be configured to receive electrical energy such as for example from a solar panel, electrical outlet, or battery. Conversely, the electrical ports can be configured to supply electrical energy of various voltage and amperage such as for example, to run an appliance, or to charge an electric bike, a cell phone, or other motorized electric device.

As discussed previously, power stack 101 comprises a power module 250 mated to a series of interconnected batteries and terminating with the electrical nest 108. The power module can comprise a variety of features that may be known in the prior art. For example, in one embodiment, the power module is in the form of a VOLTAFREE VFP 1000 power station. The power module 250 comprises a module body 252 that in this embodiment is substantially block like although other profiles can be used that are conducive to mating with a battery. The power module 250 in an operational configuration as shown, comprises a superior surface 254 facing upward and an inferior surface 255 facing downward. Projecting from the inferior surface 255 is a power toe 256 and a power heel 257. The power toe and power heel are defined by lateral faces 258 facing laterally, a rear face 259 facing rearward, and a front face 260 facing the front. A toe lip 261 extends from one end of the power toe for interlocking with a battery. These features on the inferior surface are not shown but replicate the interlock construction of the complementing battery depicted in FIG. 10.

The power module 250 comprises an operational face on which various electrical ports and power display are located. For example, the electrical ports can include DC supply ports 264 such as a USB-C 265, a 5V supply 266, a Qualcomm USB 5V quick charge 267, and a 12V supply 268 such as a car plug. The electrical ports can include an AC supply port 269 such as a 110V electrical outlet and can also include a power input port 270 such as to receive energy from a solar panel.

Some embodiments of the power module 250 include a power display 272 to display various information such as the input power 273 that is received such as from a solar panel, the output power 274 that is being delivered such as to a connected electric heater, a charge monitor 275 to indicate the percentage of battery charge wherein 100% indicates full charge, a display control button 276 to turn the display on and off, a fuse 277 to protect circuits, an output time display 278 indicating how long the battery power will last at the current output, an input time display 279 indicating the amount of time until full charge, and an on/off control 280 to power or shut down the power module.

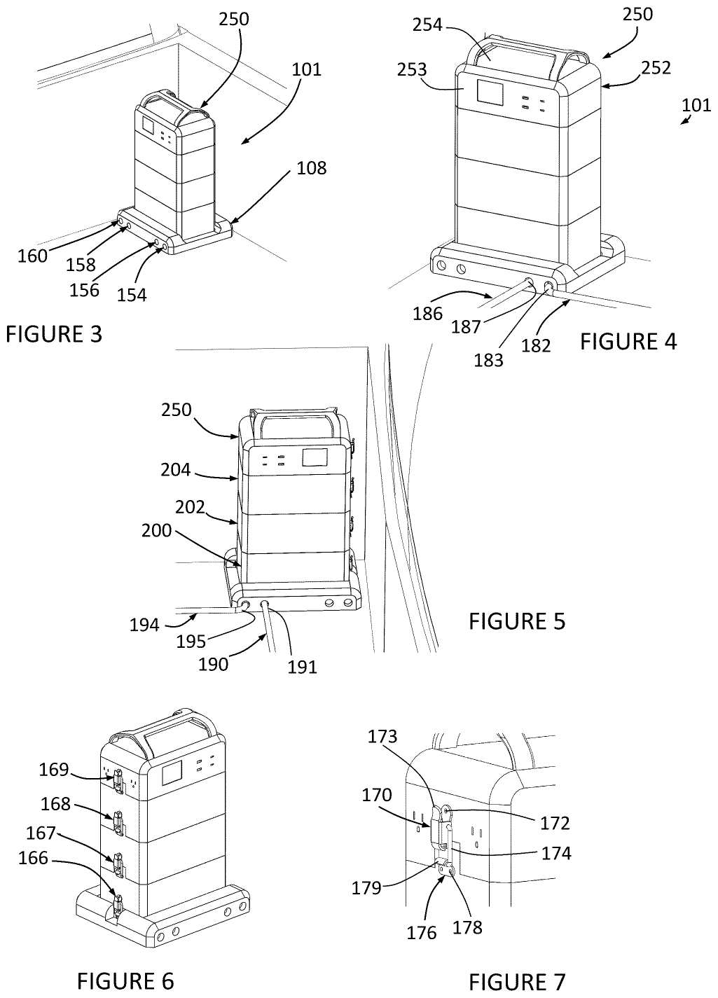

The operational configuration depicted in FIGS. 3-7 includes one or more stacked batteries positioned between power module 250 and electric nest 108. Depicted here is electric nest 108 coupled with first battery 200, which is coupled with second battery 202, which is coupled with third battery 204, which is coupled with power module 250. These components have a releasable interlock architecture providing releasable fixation between the components. In this embodiment, the releasable interlock architecture is in the form of foot, heel, and toe features discussed herein. In addition, a secondary fixation system can be used. For example, a first latch 166 can be used to lock together electric nest 108 and first battery 200, whereas a second latch 167 can be used to lock together first battery 200 to second battery 202, and whereas a third latch 168 can be used to lock together second battery 202 to third battery 204, and whereas a fourth latch 169 can be used to lock together third battery 204 to power module 250. Other types of interlocking mechanisms known in the art can be used for this same purpose. Here the latches comprise a pivoting upper latch portion 170 having an upper latch handle 173 for activating with a user's fingers. A restraint arm 174 extends downward from the upper latch portion for engaging with a lower latch catch 179 of a lower latch portion 176. Upper latch fixation holes 172 extend through an upper latch mount face 171 to house fasteners to hold the upper latch to a battery or power module. Similarly, lower latch fixation holes 178 extend through a lower latch mount face 177 to house fasteners to hold the lower latch to a battery or power module.

The batteries can assume a variety of profiles provided they have architecture conducive to releasably mating to some form of electric nest 108 and power module 250. FIGS. 10-14 provide various views of one style of battery depicted here as first battery 200. Battery 200 comprises a substantially block like battery body 216 having an external face 217 facing laterally from the sides, a superior face 218 facing superiorly, and an inferior face 219 facing inferiorly. A battery electrical pod 220 extends upward from superior face 218 on one end and is defined by pod side faces 222 on the sides and terminating in pod upper surface 221 superiorly. Extending into superior face 218 is first terminal 223 and second terminal 224 which are essentially positive and negative terminals for transmitting power from and to the battery. On an external face 217 of the battery electrical pod 220 are superior latch fixation holes 225 to receive fasteners to secure a lower latch portion 176 thereto. Also, on external face 217 is inferior latch fixation holes 226 to receive fasteners to secure an upper latch portion 170 thereto.

Extending inferiorly from inferior face 219 of the battery is battery heel 229 and battery toe 228 which are spaced from each other. The battery heel and battery toe are defined by lateral faces 230 facing laterally, rear faces 231 facing rearward, end face 234 facing downward, and front faces 232 facing frontward. A toe lip 233 extends laterally from one end of the battery toe 228 for engaging a complementary electric nest or another battery.

Located directly inferior to the battery electrical pod 220 is pod receiver 236 which is inset into battery body 216 at the intersection of the external face 217 and inferior face 219. Pod receiver 236 is defined by guide faces 238 facing radially, and terminal face 237 facing battery electrical pod 220. Projecting outward from terminal face 237 are first contact 239 and second contact 240 which are configured for electrical connection to either electrical nest 108 or another battery.

Inset into superior face 218 of the batteries is battery toe receiver 208 and battery heel receiver 212. In this embodiment, battery toe receiver 208 is generally rectangular and is defined by radially facing battery toe receiver face 211 which terminates at upward facing battery toe receiver floor 209. Battery toe receiver roof 210 extends below superior face 218 to house toe lip 233 when interlocking these parts. Battery heel receiver 212 is generally rectangular and is defined by radially facing battery heel receiver face 214 which terminates at upward facing battery heel receiver floor 213.

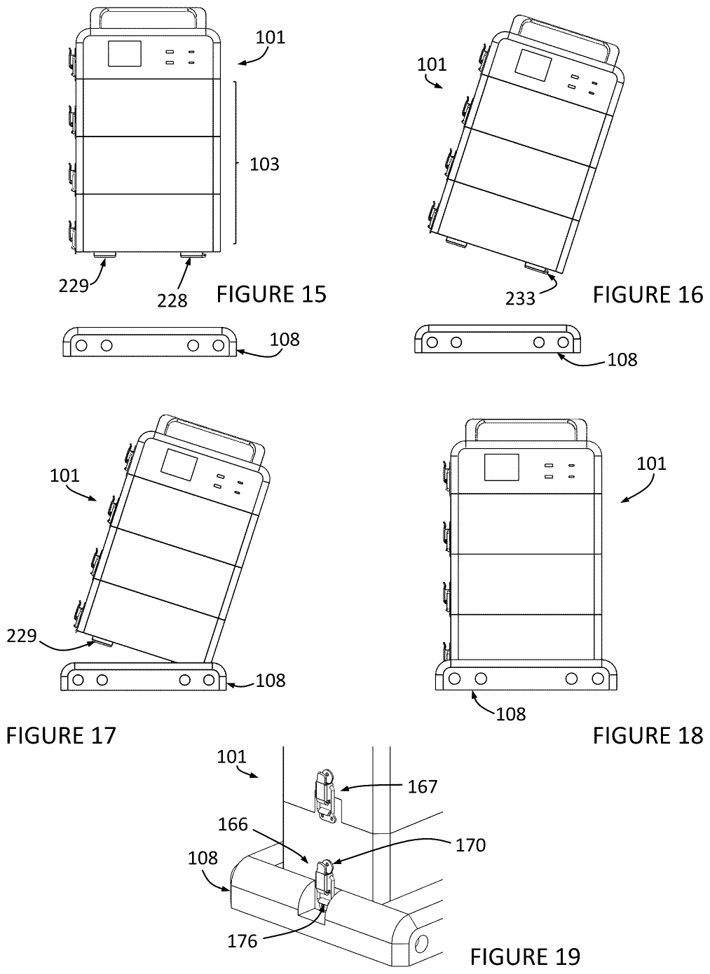

FIGS. 15-19 depict a method for engaging and disengaging the power stack 101 to electric nest 108. The steps include aligning the power stack above electric nest 108 (FIG. 15). Tilting the power stack 101 such that the exposed toe lip 233 is angled downward (FIG. 16). Engaging the toe lip 233 in the toe receiver 123 of the electric nest 108 (FIG. 17). Lowering the power stack such that the battery heel 229 is seated in the heel receiver 127 of the electric nest 108 (FIG. 18), and latching the restraint arm 174 to the lower latch portion 176 thereby securing the power stack 101 (FIG. 19). Removal of the power module 250 and one or more batteries from remaining batteries and electric nest 108 is a reversal of these steps.

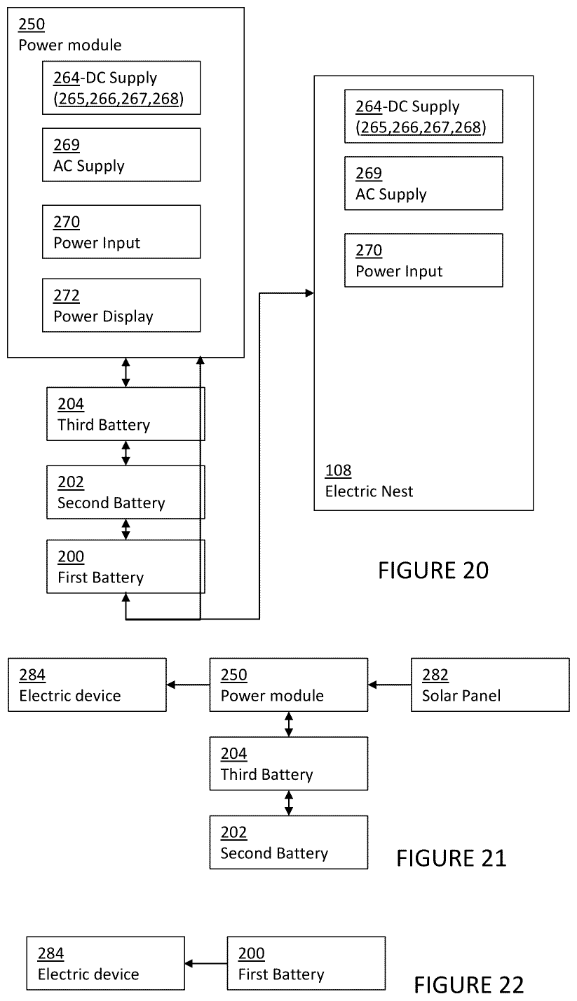

The portable power system described herein is a convenient solution to proving portable power practically anywhere. FIG. 20 is a graphic representing one embodiment of the electronic relationship between the power module 250, the batteries (200,202,204), and the electric nest 108 when attached to the vehicle. Of course, various power input devices such as a solar panel can be attached to provide power to the system and charge the battery. In addition, various electric devices such as an electric refrigerator can be electrically connected to the supply port to operate.

FIG. 21 is a graphic representing one embodiment of the electronic relationship between the power module 250, and one or more stacked batteries. The system depicted is completely portable in that it can be removed from the electric nest that is fixed to a vehicle and transported to remote places. Here the system can power or charge electronic devices 284, and can also renew its own power by attachment of a portable solar panel 282 to a power input on the power module.

FIG. 22 is a graphic representing one embodiment whereby a battery from the system, such as first battery 200 is removed and mated directly to an electric device 284 such as a power tool. Later the battery is reintegrated into the power configurations of FIG. 20 and FIG. 21 for recharging.

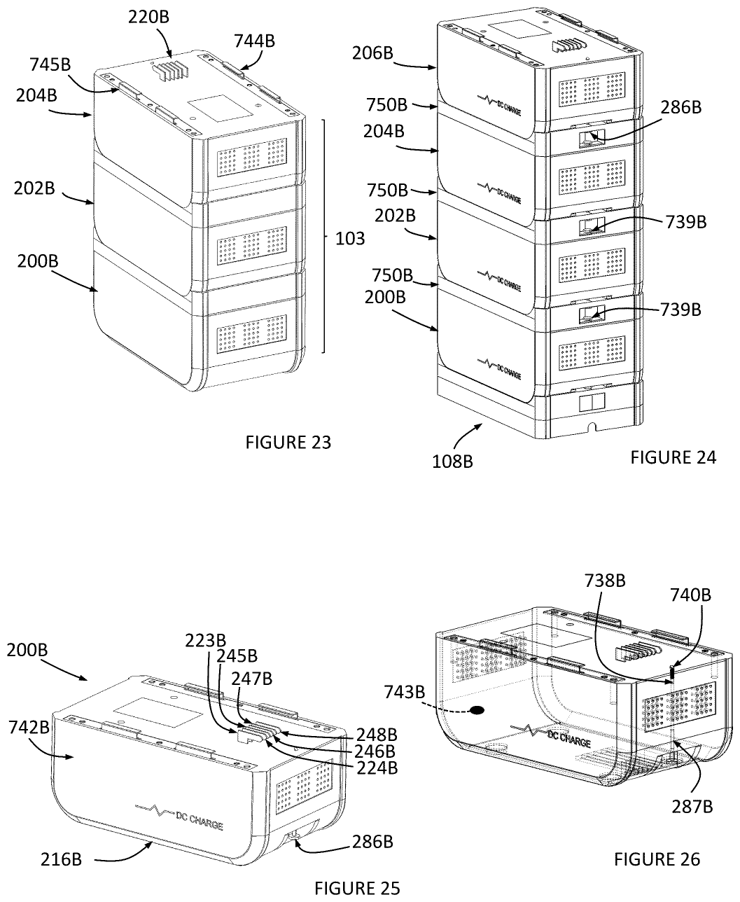

FIG. 23-24 depict opposing views of another embodiment of a battery stack comprising first battery 200B, second battery 202B, third battery 204B, and fourth battery 206B. It this embodiment, the batteries are releasably coupled by the use of a mating plate 750B that is releasably fixed to the bottom of the batteries. The mating plate engages one end of a battery and the other end of the mating plate is fixed to the battery by use of an interlock fastener 286B disposed in an interlock faster hole 287B typically by threaded interaction therebetween.

Extending vertically into the superior face of the batteries is an interlock pin hole 738B configured to house an interlock pin 740B and interlock spring 741B that biases the interlock pin upwards to interfere with the mating plate 750B thereby preventing translation of an adjacent battery and thus preventing release of the battery from the mating plate. An interlock release button 739B is housed within mating plate 750B and is aligned with the interlock pin in an operational configuration. Pressing the interlock release button lowers the interlock pin 740B such that it no longer interferes with translation between the battery and mating plate and thus translatory separation therebetween can occur.

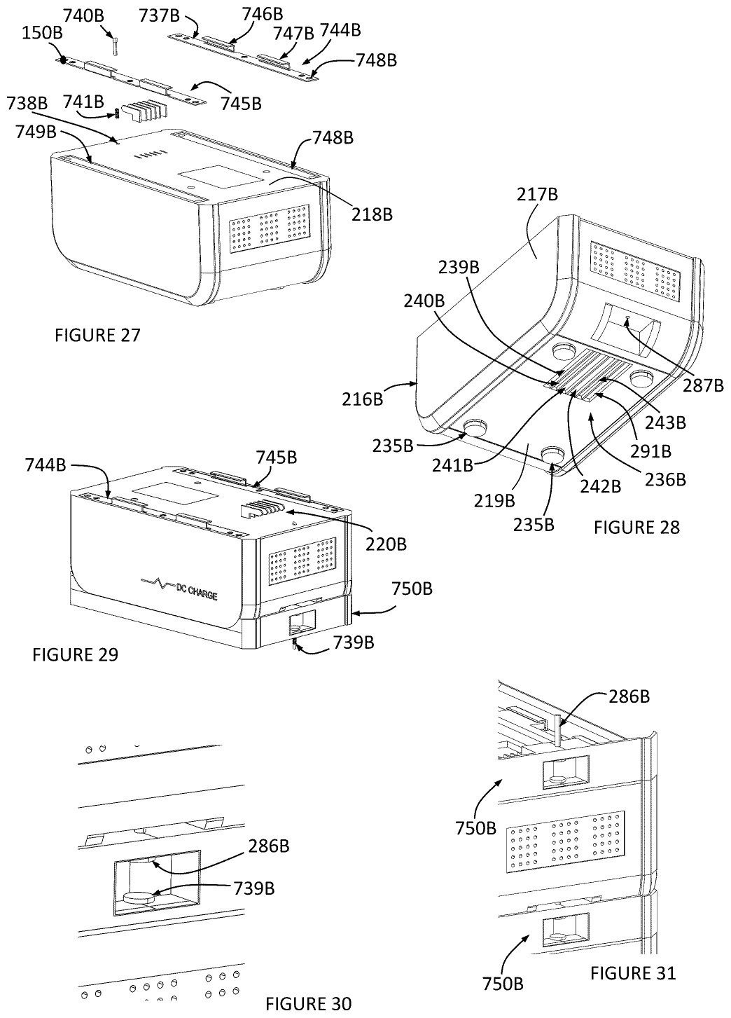

The batteries in this embodiment comprise an elongate cube battery body 216B with an outer battery shell 742B defining an internal space in which a plurality of battery cells 743B are housed. As noted in FIG. 27, the battery comprises a first capture rail 744B and a second capture rail 745B for releasable engagement with the adjacent mating plate. The capture rails comprise a capture base 737B that is secured using a plurality of fasteners 150B in a first rail recess 748B or a second rail recess 749B inset into superior face 218B of battery body 216B. Extending from the capture rails are an L-shaped first capture tongue 746B and second capture tongue 747B. When mated with an adjacent mating plate 750B, the capture tongues are first elevated into a first capture groove 757B and second capture groove 758B of the mating plate, then the battery is translated such that they interlock with first lock boss 755B and second lock boss 756B. Extending from the superior face 218B of the battery is a battery electrical pod 220B. In this embodiment, the battery electrical pod comprises a plurality of electrical terminals such as first terminal 223B, second terminal 224B, third terminal 245B, fourth terminal 246B, fifth terminal 247B and sixth terminal 248B (FIG. 25). Some of these terminals communicate with battery cells 743B in the batteries whereas other terminals carry other electrical signals up and down the stack of batteries for operation of the electrical nest, accessories connected to it, and to the power module. Extending upward through the inferior face 219B (FIG. 28) are a plurality of electrical contacts (first contact 239B, second contact 240B, third contact 241B, fourth contact 242B, fifth contact 243B, and sixth contact 291B) which are configured to align with terminals from battery electrical pod 220B. The actual number of terminals and contacts can vary according to electrical demands of the system. Like the capture tongues engaging with the capture grooves, during stacking the electrical contacts 239B-243B, 291B have translating engagement with respective electrical terminals 223B, 224B, 245B-248B and are thus able to pass along the electrical signals up and down through the stack.

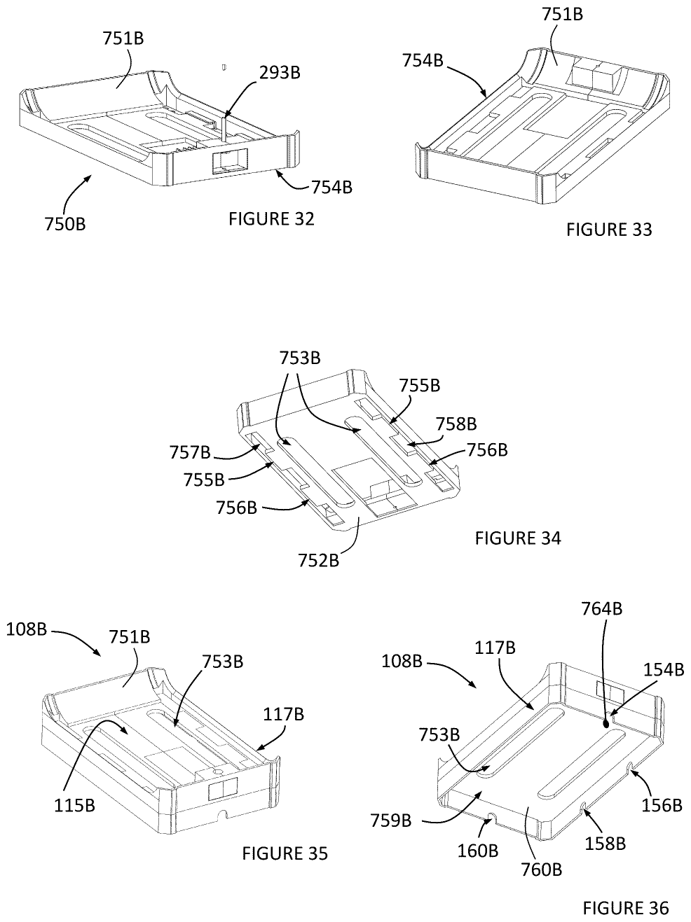

FIGS. 32-34 depict various views of one embodiment of a mating plate 750B having a generally rectangular mating plate body 754B. The mating plate comprises an upper mate face 751B that generally complements the bottom side of the batteries. Note in this embodiment, the upper mate face is sloped on each end to match the rounded nature of the bottom of the battery at its ends. Other complementing profiles can be used. A lower mate face 752B is generally flat to facilitate translatory engagement with the top of the adjacent battery for engaging and disengaging with it. Battery lift recesses 753B extend through the mate plate 750B and electrical nest 108B to house battery lifts 235B (pads) therein.

FIGS. 35-36 depicts another embodiment of an electrical nest 108B as used with the battery stack of FIG. 24. A foot receiver side wall 117B encircles the electrical nest which defines an electrical port cavity 759B that extends upwards towards foot receiver floor 115B and downward face 760B. Extending laterally through the foot receiver wall are a plurality of electrical ports (i.e. first electrical port 154B, second electrical port 156B, third electrical port 158B, fourth electrical port 160B etc.). In some cases, retractable electrical cords 764B extend through the electrical ports to various accessories including solar panels.

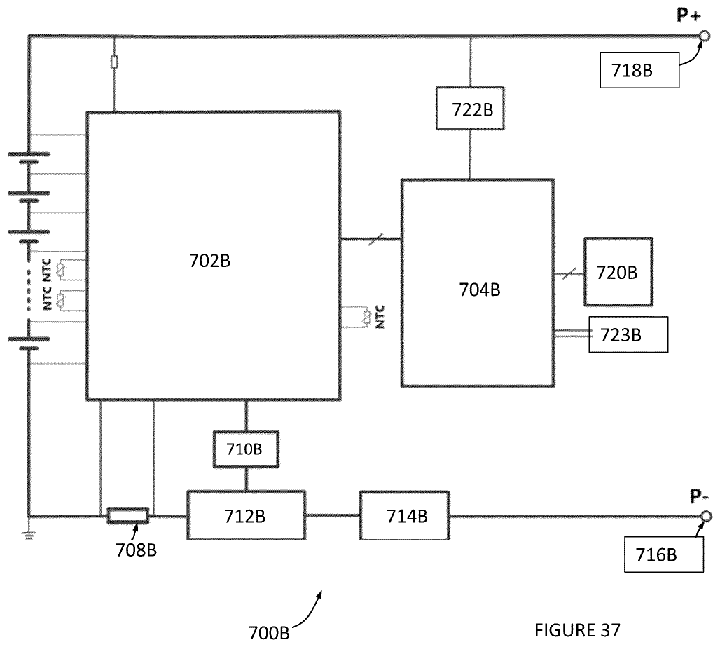

FIG. 37 depicts an electrical schematic of one embodiment of the power stack circuitry 700B. This includes an analog front end 702B, a micro-controller unit 704B which can be in various forms such a SoC (system on a chip) or PLC (prologic controller). One or more NTCs (negative temperature coefficient thermistors) can be utilized as temperature sensors that use resistance properties of ceramic/metal composites to measure temperature of various components in the system (i.e. first NTC 724B, second NTC 726B, and third NTC 728B). A current sampler 708B can be used to measure various levels of current going through the system during charging. Various software drivers 710B are utilized in the system to assist in operation of various components and for controlling the system by an app such as on a smartphone. Charge-discharge MOSFET 712B is utilized to control a battery's charging and discharging. A charge current limiter 714B is an over-charging controller. Battery negative 716B and battery positive 718B indicate battery inputs. An RS-485 communications port 720B is included for communication with other electrical components. Other components include battery stack power 722B and a SW 723B.

In a preferred embodiment, the portable power system comprises the following features, however, variations can be used as will be recognized by those skilled in the art:
Material: Durable, weather-resistant plastic with rubberized footing for stability.
Connectivity: Wi-Fi and Bluetooth for app communication.
Ports: Multiple retractable cords with universal connectors (USB-A, USB-C, micro-USB, and proprietary connectors for bikes, scooters, OneWheels®, and other motorized boards).
Features: Solar panel input port, device charging ports, battery stack connectors.
Software: Firmware for managing connections, charging, and communication with the app.

General Battery Units specifications include:
Capacity: 748.8 Wh per battery.
Material: High-impact resistant casing.
Connectivity: Modular connectors for stacking on the smart base.
Features: LED indicators for battery level, waterproof and dustproof design.

App Integration specifications include:
Functionality: Real-time monitoring of charging status, battery levels, solar input, and energy consumption.
Features: Customizable notifications, remote control of ports, and energy usage statistics.

Battery Specifications:

Lithium-ion cells with protection circuits for overcharge, over-discharge, and short circuit.

It is noted that the terms “substantially” and “about” and “generally” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. A portable power system substantially as described and illustrated.

2. A method of using a portable power system substantially as described and illustrated.
